(19) United States
(12) Patent Application Publication
(10) Pub. No.: US 2026/0235643 A1
(43) Pub. Date: Aug. 13, 2026

(54) SCANNING PROBE MICROSCOPY DEVICE AND METHOD OF SCANNING A SURFACE OF A MATERIAL LAYER

(71) Applicant: DEMCON TSST B.V., ENSCHEDE (NL)

(72) Inventors: Emiel Daniël RUTGERS, ENSCHEDE (NL); Augustinus Josephus Helena Maria RIJNDERS, ENSCHEDE (NL); Dominic POST, ENSCHEDE (NL)

(73) Assignee: DEMCON TSST B.V., ENSCHEDE (NL)

(21) Appl. No.: 19/155,337

(22) PCT Filed: Feb. 20, 2024
(86) PCT No.: PCT/NL2024/050084

§ 371 Date: Aug. 11, 2025

(30) Foreign Application Priority Data
Feb. 24, 2023 (NL) 2034222

(51) Int. Cl. G01Q 30/20

(52) U.S. Cl. CPC G01Q 30/20

(57) ABSTRACT

Scanning probe microscopy device, comprising a probe and a substrate holder comprising a substrate holding portion for holding a material deposition substrate, where-in the substrate holder is movable relative to the probe between a deposition state, in which the substrate holding portion is positioned to hold the substrate for a material layer to be deposited on a surface of the substrate, and a scanning state, in which the substrate holding portion is positioned adjacent to the probe and the probe is arranged for scanning a surface of the deposited material layer, wherein the substrate holder is rotatable between the deposition state and the scanning state about a rotation axis and the substrate holding portion is arranged to hold the substrate with its surface facing radially outwards with respect to the rotation axis.

The present invention relates to a scanning probe microscopy device, a material deposition device comprising the scanning probe microscopy device, and a method of scanning a surface of a material layer using the scanning probe microscopy device.

Deposition is a technique for forming a thin film on a substrate. For example, in pulsed laser deposition (PLD) which is often performed inside a vacuum chamber, a pulsed laser beam is directed to a target of material, such as a sintered or compressed target material, and vaporises the material to create a plasma plume. The vaporised material condenses as a thin film on a substrate facing the target. As the material particles bind to the surface, they grow into islands which merge into a thin material layer.

Using a deposition technique, it is possible to produce thin films with atomic layer precision. To precisely control the properties of the thin film such as uniformity, the deposition process is to be controlled based on monitoring of the material layer growth during the formation process. The growth of the material layer on the substrate can be observed by scanning the surface of the deposited material layer using a scanning probe microscope, wherein the tip of a probe is scanned over the material layer surface for measuring its profile to determine the quality and properties of the thin film such as morphology and electrical and magnetic properties.

In for instance atomic force microscopy (AFM), a type of scanning probe microscopy (SPM), a piezoelectric element causes a spring-like cantilever with a needle at its free end to oscillate. A laser beam is reflected by the cantilever and the reflected laser beam reaches a detector. Scanning the needle tip across the surface causes the cantilever to deflect, which changes the laser interference based on which the surface profile of the material layer can be measured.

There are probes, referred to as self-sensing piezo cantilevers, wherein the cantilever movement is measured directly, i.e., without fibres and lasers that are generally used for optical measurements as described above. In a similar manner, as an alternative to the cantilever, a probe tip may be arranged on a quartz tuning fork. As with the self-sensing piezo cantilever, no optical measurement is required, which reduces the needed space considerably. More in general, any suitable AFM or SPM technique may be employed.

The scanning probe is spaced from the deposition unit to not interfere with the deposition process and vice versa. The substrate with the material deposited thereon is then shifted from the deposition unit to the scanning probe after each deposition iteration and shifted back again to the deposition unit after the measurement. Each time, the needle is to be repositioned above the material layer surface. As deposited material particles can grow into islands in a matter of seconds, the SPM measurement is to be fast to optimally collect information regarding island growth. In current systems, such as disclosed in patent publication WO2008/049570, the substrate is rapidly translated between the deposition position and the scanning position.

A drawback of the current systems is that such a system, wherein the substrate is moved between the deposition position and the scanning position, occupies a large area.

A further drawback is that the substrate and the deposited material layer, due to the vapour deposition process taking place at high temperature, cause temperature instability in the scanning probe when moving to and away from the probe, which interferes with the measurements.

It is therefore an object of the present invention, amongst other objects, to provide an SPM device, in particular a more compact SPM device, wherein the above drawbacks are at least partially alleviated.

Hereto, according to a first aspect of the present invention, a scanning probe microscopy device is provided, in particular an AFM device, wherein the scanning probe microscopy device comprises a probe and a substrate holder comprising a substrate holding portion for holding a material deposition substrate, wherein the substrate holder is movable relative to the probe between a deposition state, in which the substrate holding portion is positioned to hold the substrate for a material layer to be deposited on a surface of the substrate, and a scanning state, in which the substrate holding portion is positioned adjacent to the probe and the probe is arranged for scanning a surface of the deposited material layer, wherein the substrate holder is rotatable between the deposition state and the scanning state about a rotation axis.

The SPM device can be conveniently installed as an add-on module in combination with a material deposition unit, such as a PLD unit, to form a material deposition system that allows in situ SPM. In the deposition state of the substrate holder, the substrate holding portion is then arranged to hold the substrate facing the material deposition unit, in particular a material source held therein.

The scanning probe microscopy device may comprise a housing with a chamber for creating a vacuum chamber to provide suitable process conditions, wherein the substrate holder and the probe are arranged in the chamber.

By rotating the substrate holder, the substrate holding portion for holding a substrate can be efficiently moved from a deposition position, in which the substrate held by the substrate holding portion faces the material deposition unit for a material layer to be deposited on the substrate surface, to a scanning position in which the held substrate faces the scanning probe. The probe is then preferably movable in a scanning plane that is essentially parallel to the substrate held by the substrate holding portion in the scanning state. The substrate holding portion is thus rotatable between the deposition position and the scanning position.

Especially in case the substrate is to be moved to different deposition positions because a combination of layers of different materials is to be formed and/or because layers are to be deposited by different deposition techniques such as molecular-beam epitaxy and chemical vapour deposition, the substrate can be moved along the various positions by means of the rotating substrate holder more efficiently relative to a linearly translating substrate holder. The different material deposition units may surround the rotation axis and thereby define various deposition positions around it, such that the substrate can be moved successively along the different positions upon rotation of the substrate holder. As such, the substrate holder is preferably rotatable relative to the probe between the scanning state and a plurality of deposition states, in each of which the substrate holding portion is arranged to hold the substrate for a material layer to be deposited on the surface of the substrate.

Preferably, the substrate holding portion is arranged to hold the substrate with its surface facing radially outwards with respect to the rotation axis, i.e., in the deposition state and in the scanning state. This way, the substrate surface faces a different direction upon rotation of the substrate holder and a more compact system can be obtained, since the scanning position can be made sufficiently isolated from the deposition position without the need to translate the substrate holder over a large distance. Moreover, by rotating the substrate holder, the substrate holding portion can be moved between positions at high speed more efficiently, such that the SPM measurement after each deposition iteration can be performed faster and the growth of islands of deposited material can be monitored more optimally.

According to a preferred embodiment of the SPM device, the substrate holder is cylindrical, wherein the cylindrical holder is arranged axially rotatable about the rotation axis. The cylindrical substrate holder is thus rotatable about its cylindrical axis or an axis parallel thereto and may be rotationally supported by, e.g., bearings at either end. Preferably, the substrate holding portion is provided on a cylindrical side of the holder, such that the substrate is held with its surface facing radially outwards.

In SPM, as described above, the probe may comprise an oscillating cantilever with a needle-like tip. When the tip is positioned sufficiently close to the substrate or the material layer thereon, the atoms or particles may attract the tip and thereby slightly deflect the cantilever towards the substrate. During the scanning, when the cantilever oscillates, a piezoelectric element that is arranged to control the position of the probe along an axis perpendicular to the substrate may be configured to maintain a constant average distance between the tip and the substrate or material layer by means of a control loop that is, e.g., configured to ensure that the tip is attracted by a constant attraction force of the substrate or material layer. This can be referred to as a non-contact mode. Alternatively, a different mode is possible, which can be referred to as a contact mode, in which the tip may contact the surface of the substrate or the material layer in order to also measure, e.g., electrical properties of the surface at the expense of a tolerable damage to the surface and/or the tip.

By maintaining the distance during oscillation of the probe for obtaining the surface profile measurements in the non-contact mode, the tip is prevented from colliding with and damaging the substrate or material layer and from becoming damaged itself. However, when moving the substrate from the deposition position towards the tip at high speed, it is to be prevented that the substrate damages the tip nonetheless.

To that end, according to a further preferred embodiment, the substrate holding portion is arranged to hold the substrate perpendicular to the radial direction, particularly in the scanning state. Here, the radial direction can be defined as the direction perpendicular to the rotation axis and extending through both the substrate holding portion and the rotation axis. As such, when rotating the substrate holder from the deposition state to the scanning state, more specifically upon moving the substrate holding portion into the scanning position, the substrate holding portion is moved substantially parallel to the scanning plane of the probe. Due to the rotational movement, it can be ensured that the substrate does not collide with the tip upon moving into the scanning position, since the substrate can be positioned adjacent to the tip without substantially moving the substrate towards the tip in the radial direction. Instead, the substrate is moved tangentially relative to the rotation axis, which tangential direction is essentially parallel to the scanning plane in the vicinity of the probe. Preferably, at the start of a deposition process, the relative position between the probe and the substrate in the scanning position is optimised in an initial calibration step, in which the probe is properly positioned relative to the substrate, particularly with regard to the distance between the probe and the substrate in the radial direction.

According to a second aspect of the present invention, a scanning probe microscopy device, preferably according to any of the above embodiments, is provided, wherein the scanning probe microscopy device comprises a scanning probe microscope, provided with a probe, and a substrate holder comprising a substrate holding portion for holding a material deposition substrate for a material layer to be deposited on a surface of the substrate, wherein the substrate holding portion is positioned adjacent to the probe and the probe is arranged for scanning a surface of the deposited material layer, wherein the scanning probe microscopy device further comprises a shield member arranged between the scanning probe microscope and the substrate holder, wherein the shield member is provided with an opening therethrough that is located adjacent to the probe, wherein the probe is arranged for scanning the surface of the deposited material layer through the opening. Preferably, the substrate holder is movable relative to the probe between a deposition state, in which the substrate holding portion is positioned to hold the substrate for a material layer to be deposited on a surface of the substrate, and a scanning state, in which the substrate holding portion is positioned adjacent to the probe and the probe is arranged for scanning a surface of the deposited material layer.

The shield member is for shielding the scanning probe microscope from material particles, in particular particles from the deposition process. By arranging the shield member between the scanning probe microscope and the substrate holder, the scanning probe microscope can be shielded effectively. The shield member may be plate-like and arranged substantially parallel to the scanning plane of the probe.

One of the factors that influence the deposition of the material layer is the temperature of the substrate. Specifically, the substrate surface temperature affects the nucleation density. The substrate may be heated on a heating plate to enhance a property of the thin film, such as crystallinity, for an improved quality. When the substrate is positioned adjacent to the probe, the probe may be heated indirectly due to the increased temperature of the substrate. In case the substrate holder is movable between scanning and deposition states, the temperature of the probe may vary as the holder moves from the scanning state to the deposition state and back again. This temperature instability generally has a negative effect on the probe, in particular the scanning measurements. Therefore, the probe may be cooled to prevent its temperature from experiencing large increases when the heated substrate is in the scanning position. However, instead, it is preferred if the SPM device further comprises a shield heating system arranged to heat the shield member. Hereto, the shield heating system may comprise one or more heating elements, wherein the shield member is provided therewith. Via the heated shield member, the probe can be heated, albeit indirectly, and maintained within a suitable temperature range irrespective of the relative position of the substrate. As such, by heating the shield member, the temperature of the probe can be stabilised despite the moving substrate holder. The shield heating system is then preferably arranged to maintain a temperature of the shield member between 400 and 700 kelvins, preferably between 500 and 600 kelvins.

It was found that, by heating the probe instead of cooling, the overall energy efficiency of the system could be enhanced to an unforeseeable extent.

According to a third aspect of the present invention, a scanning probe microscopy device, preferably according to any of the above embodiments, is provided, wherein the scanning probe microscopy device comprises a probe and a substrate holder comprising a substrate holding portion for holding a material deposition substrate, wherein the scanning probe microscopy device further comprises a holder heating system arranged to heat the substrate holder, in particular the substrate holding portion. Preferably, the substrate holder is movable relative to the probe between a deposition state, in which the substrate holding portion is positioned to hold the substrate for a material layer to be deposited on a surface of the substrate, and a scanning state, in which the substrate holding portion is positioned adjacent to the probe and the probe is arranged for scanning a surface of the deposited material layer. It is then further preferred if the substrate holder is rotatable between the deposition state and the scanning state about a rotation axis.

The holder heating system preferably comprises a laser unit arranged to emit a laser beam towards the substrate holder. The laser beam may be, e.g., an infrared laser beam. Particularly in case the substrate holder is cylindrical as described above, the substrate holder may be provided with an optical system arranged to direct the beam through the holder towards the cylindrical side of the holder, preferably to the substrate holding portion. Specifically, the cylindrical holder may be provided with an inner space and an aperture into the inner space, which for instance form at least part of the optical system, wherein the laser unit is arranged to direct the laser beam into the inner space through the aperture. That is, the holder may be at least partly hollow and provided with a cavity extending inwards from a cylindrical end side surface. Preferably, the optical system comprises an optical element provided in the inner space and arranged to direct the laser beam towards the cylindrical side or the substrate holding portion. Hereto, the optical element may have a reflective surface arranged to reflect the laser beam towards the cylindrical side.

As the laser beam is directed into the cylindrical holder through a cylindrical end side surface, the laser beam may be collinear with the cylindrical and/or rotation axis of the substrate holder. If the optical element is arranged stationary relative to the holder, the optical element is rotatable together with the cylindrical holder. Consequently, as the optical element is arranged to direct the laser beam, that is collinear with the axis, from within the holder towards the cylindrical side, it can be ensured that the same portion of the holder, for instance the substrate holding portion, is heated without adjusting the laser unit even while the optical element is rotating together with the holder.

As described above, the temperature of the probe may vary as the substrate holder moves from the scanning state to the deposition state and back again. This temperature instability may negatively affect the probe. Therefore, according to a preferred embodiment of the SPM device, the holder heating system is arranged to heat a second portion of the substrate holder, wherein the second portion is positioned adjacent to the probe in the deposition state. Via the heated second portion of the substrate holder, the probe can be heated and maintained within a suitable temperature range while the substrate holding portion is in the deposition position. This way, the temperature of the probe can be stabilised despite the substrate holder moving between the deposition state and the scanning state.

Preferably, the second portion is heated in addition to the substrate holding portion. For example, the optical element may be arranged to split the laser beam into a first beam and a second beam, wherein the optical system is arranged to direct the first beam towards the substrate holding portion and the second beam towards the second portion.

According to a preferred embodiment of the SPM device, the holder heating system is arranged to maintain a first temperature of the substrate holding portion and a second temperature of the second portion, wherein a difference between the first temperature and the second temperature is less than 100 kelvins, preferably less than 50 kelvins. In general, it is preferred if the first temperature and the second temperature are approximately the same. This way, the temperature stabilisation of the probe can be further enhanced.

According to another aspect, a material deposition device is provided, which comprises a scanning probe microscopy device according to any of the above embodiments and a material deposition unit, in particular a pulsed laser deposition unit, for depositing a material layer onto a substrate, wherein the material deposition unit is arranged to deposit a material layer on a surface of a substrate held by the substrate holding portion in the deposition state.

According to yet another aspect, a method of scanning a surface of a material layer is provided, wherein the method comprises the steps of:
providing a material deposition substrate;
providing a scanning probe microscopy device according to any of the above embodiments, wherein the substrate holding portion holds the substrate;
providing a material layer on a surface of the substrate;
moving, particularly rotating, the substrate holder to the scanning state;
scanning a surface of the material layer in the scanning state, using the probe.

Preferably, the step of providing the scanning probe microscopy device comprises providing a material deposition device as described above, wherein the step of providing the material layer on the substrate surface comprises depositing the material layer on the substrate surface in the deposition state, using the material deposition unit. The method may then comprise the steps of alternatingly rotating the substrate holder between the deposition state, in which material is deposited, and the scanning state, in which the surface of the material layer on the substrate is scanned.

The present invention is hereinafter further elucidated with reference to the attached drawings, wherein:

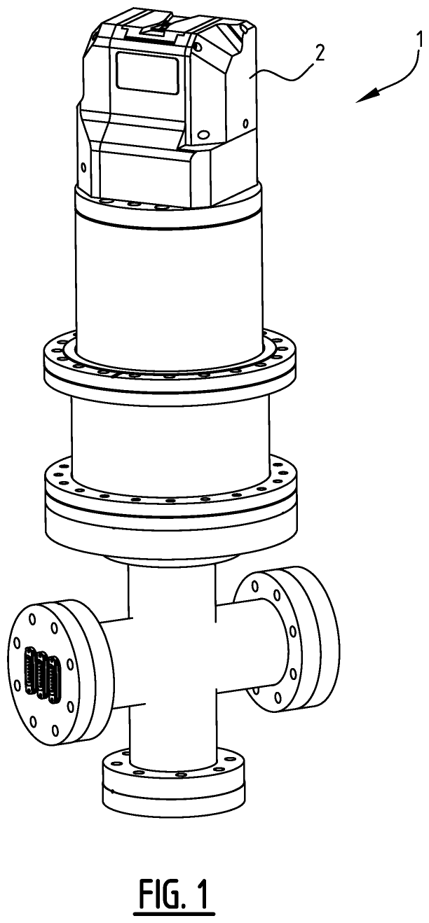

FIG. 1 shows an embodiment of a scanning probe microscopy device;

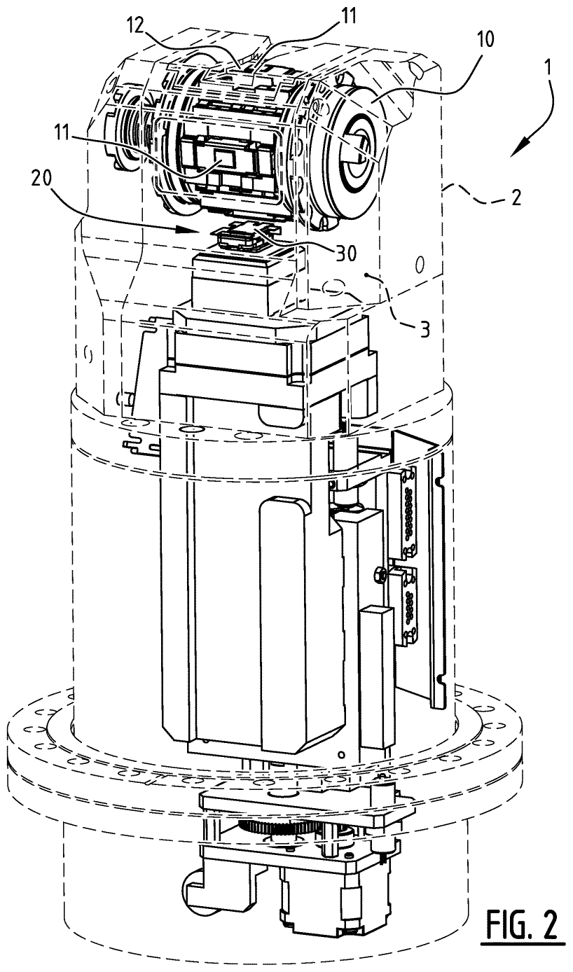

FIG. 2 represents a cutaway view of a part of the SPM device;

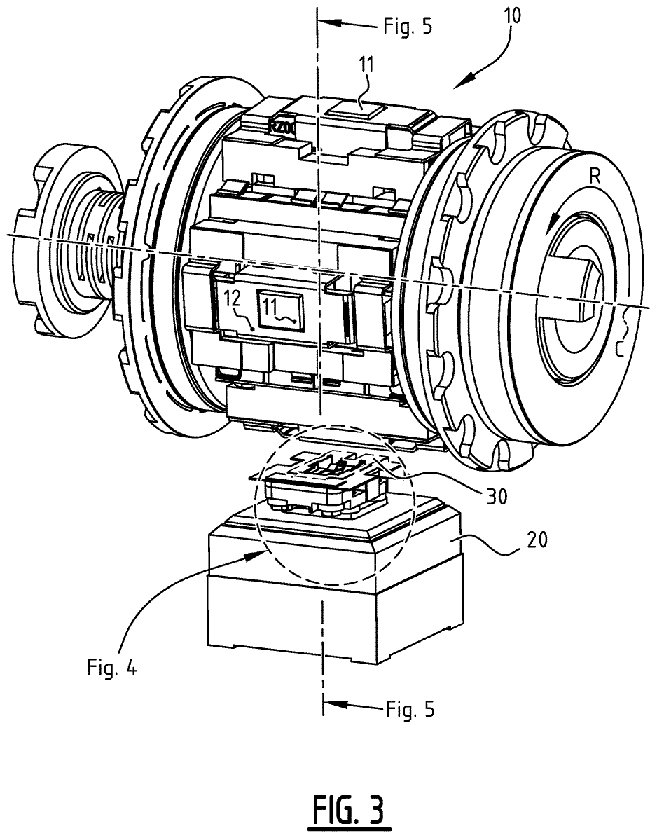

FIG. 3 shows the cylindrical substrate holder of the device and part of the microscope;

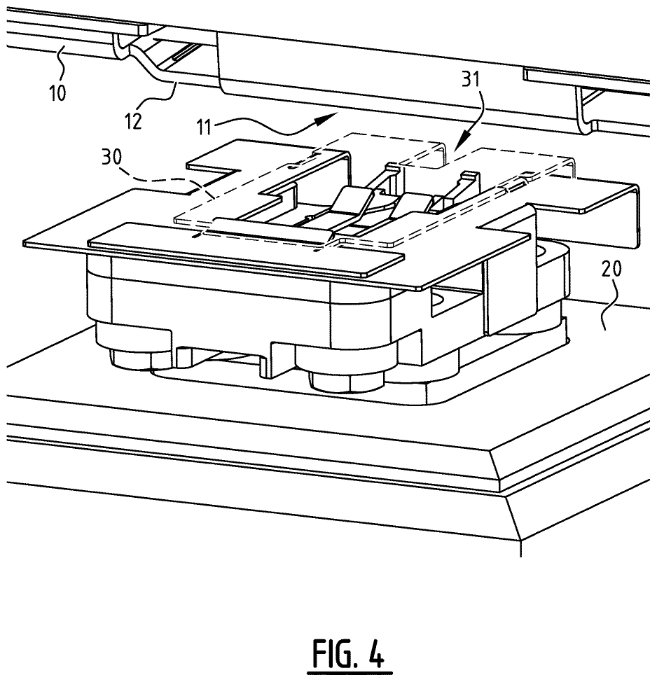

FIG. 4 represents a close-up view of FIG. 3;

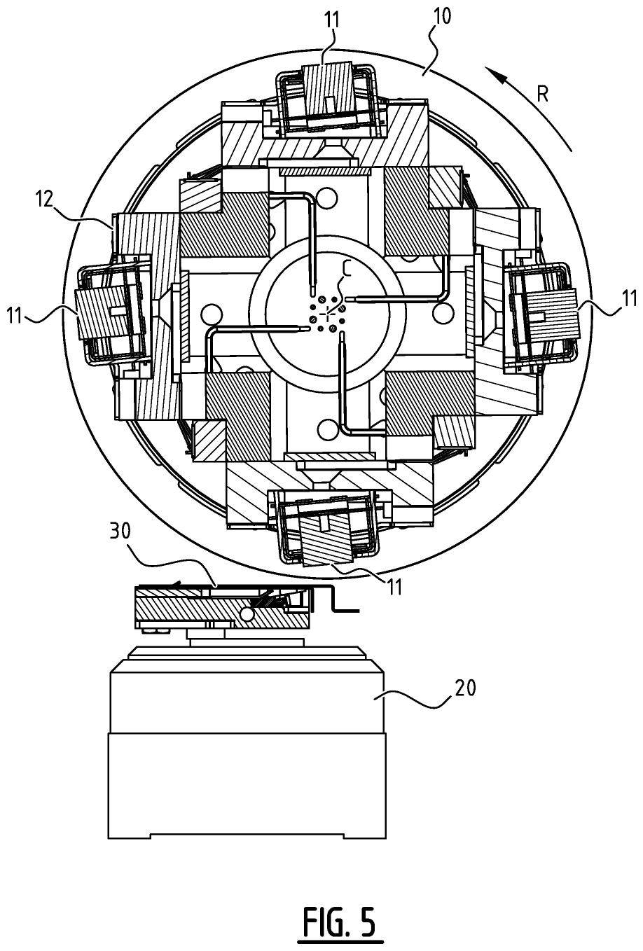

FIG. 5 represents a cross-sectional view of the holder and the microscope;

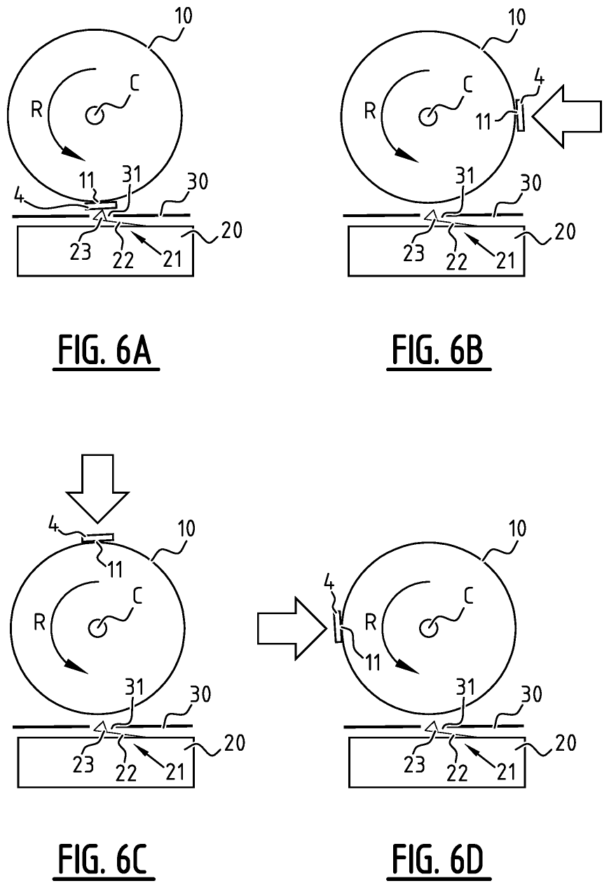

FIGS. 6A-D schematically represent the scanning state and various deposition states of the substrate holder;

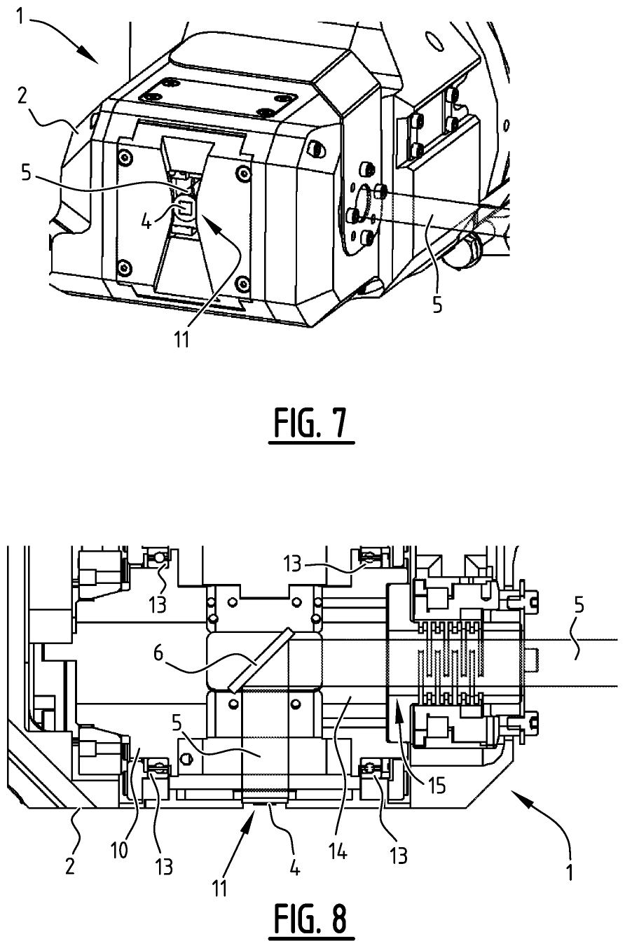

FIG. 7 shows a part of an SPM device according to a second embodiment;

FIG. 8 represents a sectional view of the substrate holder of the second embodiment.

FIGS. 1-5 depict a scanning probe microscopy device 1, in particular an atomic force microscopy device. The device 1 comprises an outer housing 2 that is provided with a chamber 3 for creating a vacuum chamber in which components of the device 1 are installed. The vacuum chamber 3 can provide suitable process conditions for the components of the device 1. In FIG. 2, the housing 2 is represented by dashed lines and made transparent to illustrate the components of the device 1 inside the housing 2.

The device 1 comprises a scanning probe microscope 20 that comprises a probe. Although the probe is too small to show in FIGS. 1-5, such a probe is schematically depicted in FIGS. 6A-D, wherein the probe 21 is formed as a spring-like cantilever 22 with a needle 23 at its free end. In the microscope 20, a piezoelectric element is arranged to oscillate the probe 21. When a laser beam is emitted through the microscope 20, it is reflected by the cantilever 22 and the reflected laser beam reaches a detector. Scanning the needle tip 23 across a surface of a material layer causes the cantilever 22 to deflect, which changes the laser interference based on which the surface profile of the material layer can be measured.

Although the probe sensing is described here in the context of optical measurements using a laser beam, any suitable AFM or SPM technique may be employed. For instance, as a space-saving measure, a self-sensing piezo cantilever or a quartz tuning fork may be used instead.

In the following, particularly reference is made to FIG. 5, which represents a cross-sectional view in the plane denoted with A in FIG. 3. The SPM device 1 further comprises a cylindrical substrate holder 10 that comprises a plurality of substrate holding portions 11 for respectively holding a corresponding plurality of material deposition substrates. Relative to the microscope 20, the cylindrical substrate holder 10 is axially rotatable, as indicated by the arrow R, about its cylindrical axis C to move the substrate holding portion 11 from a deposition position, located away from the microscope 20, to a scanning position in which the substrate holding portion 11 is positioned adjacent to the probe and faces the probe such that the probe can scan a surface of a material layer on the substrate. The holder 10 may be bi-directionally rotatable, i.e., in the rotation direction indicated by the arrow R and the opposite rotation direction. The substrate holding portion 11 is located on a cylindrical side 12 of the holder 10, such that the substrate is held with its surface facing radially outwards with respect to the cylindrical axis C.

As depicted stepwise in FIGS. 6A-D, the substrate 4 held by the substrate holding portion 11 can be moved successively from the scanning position, in which the substrate 4 faces the probe 21 (FIG. 6A), along various deposition positions, and back again to the scanning position, upon rotation of the substrate holder 10. In a deposition position, the substrate holding portion 11 may hold the substrate 4 facing a pulsed laser deposition unit or other material deposition unit for a material layer to be deposited on a surface of the substrate 4, as illustrated by the respective arrows in FIGS. 6B-D. Different material deposition units, such as molecular-beam epitaxy and chemical vapour deposition units, may surround the cylindrical axis C of the cylindrical substrate holder 10 about which the holder 10 axially rotates. This way, a combination of layers of different materials can be formed and/or layers can be deposited by different deposition techniques.

In the following, particular reference is made to FIGS. 3-6D. The SPM device 1 further comprises a plate-like shield member 30 that is arranged between the scanning probe microscope 20 and the cylindrical substrate holder 10 to shield the scanning probe microscope 20 from material particles from any of the deposition processes. More specifically, the shield member 30 is stationary with respect to the microscope 20 by, in this example, being fixed thereto. The shield member 30 is provided with an opening 31 therethrough that is located adjacent to the probe 21. Through the opening 31, the probe 21 can scan the surface of a deposited material layer on the substrate 4 held by the substrate holding portion 11 of the cylindrical holder 10 in the scanning state.

The substrate 4 may be heated to improve the quality of the produced thin film. When the substrate 4 is positioned adjacent to the probe 21, the probe 21 may be heated indirectly due to the increased temperature of the substrate 4. The temperature of the probe 21 varies as the holder 10 moves from the scanning state to the deposition state and back again. This temperature instability has a negative effect on the scanning measurements. Therefore, the shield member 30 is provided with one or more heating elements arranged to heat the shield member 30. Via the heated shield member 30, the probe 21 can be maintained within a suitable temperature range, for example between 500 and 600 kelvins, irrespective of the relative position of the heated substrate 4.

With reference to FIGS. 7 and 8, which relate to a further embodiment of the SPM device 1, a holder heating system for heating the substrate holding portion 11 of the cylindrical substrate holder 10 is described. The substrate holding portion 11 can be seen holding a material deposition substrate 4 in a deposition position, in which the substrate 4 is positioned for a material layer to be deposited on a surface of the substrate 4. The substrate holder 10 is rotatable for moving the substrate 4 from the deposition position to a scanning position, as depicted in FIGS. 6A-D. Hereto, the cylindrical substrate holder 10 is rotationally supported by sets of bearings 13 at either end of the cylinder 10.

The cylindrical holder 10 is provided with an inner space 14. A cylindrical end side of the cylindrical holder 10 is provided with an aperture 15 into the inner space 14. The cylindrical axis of the holder 10, about which the holder 10 is rotatable, extends through the aperture 15. A laser beam 5 may be directed into the inner space 14 through the aperture 15, collinearly with the cylindrical axis of the holder 10. A mirror element 6 is provided in the inner space 14 and comprises a reflective surface arranged at an angle of about 45 degrees relative to the cylindrical axis to reflect the incoming laser beam 5 to the substrate holding portion 11 to heat the substrate 4.

The mirror element 6 is arranged stationary relative to the holder 10, such that the mirror element 6 rotates together with the holder 10 upon rotation thereof. This way, it is ensured that the same portion of the holder 10 is heated while the mirror element 6 is rotating together with the holder 10.

Alternatively, the mirror element 6 may comprise two or more distinct reflective surfaces arranged to split the incoming laser beam 5 into respective beams, of which one is directed to the substrate holding portion 11 and another to a second portion on the cylindrical side 12 of the holder 10 opposite to the substrate holding portion 11, to heat this second portion in addition to the substrate holding portion 11. Via the heated second portion of the substrate holder 10, the probe 21 can be heated and maintained within a suitable temperature range while the substrate holding portion 11 is in the deposition position. For an optimal temperature stabilisation of the probe 21, it is preferred if the substrate holding portion 11 and the second portion are maintained at substantially the same temperature.
The figures and the above description serve to illustrate specific embodiments of the invention and do not limit the scope of protection defined by the following claims.

1. A scanning probe microscopy device, comprising a probe and a substrate holder comprising a substrate holding portion for holding a material deposition substrate, wherein the substrate holder is movable relative to the probe between a deposition state, in which the substrate holding portion is positioned to hold the substrate for a material layer to be deposited on a surface of the substrate, and a scanning state, in which the substrate holding portion is positioned adjacent to the probe and the probe is arranged for scanning a surface of the deposited material layer, wherein the substrate holder is rotatable between the deposition state and the scanning state about a rotation axis and the substrate holding portion is arranged to hold the substrate with its surface facing radially outwards with respect to the rotation axis.

2. The scanning probe microscopy device according to claim 1, wherein the substrate holder is cylindrical, wherein the cylindrical holder is arranged axially rotatable about the rotation axis, and wherein the substrate holding portion is provided on a cylindrical side of the holder.

3. The scanning probe microscopy device according to claim 1, wherein the substrate holder is rotatable relative to the probe between the scanning state and a plurality of deposition states, in each of which the substrate holding portion is arranged to hold the substrate for a material layer to be deposited on the surface of the substrate.

4. The scanning probe microscopy device according to claim 1, wherein the substrate holding portion is arranged to hold the substrate perpendicular to the radial direction.

5. The scanning probe microscopy device according to claim 1, further comprising a shield member and a scanning probe microscope provided with the probe, wherein the shield member is arranged between the scanning probe microscope and the substrate holder, wherein the shield member is provided with an opening therethrough that is located adjacent to the probe, wherein the probe is arranged for scanning the surface of the deposited material layer in the scanning state through the opening.

6. The scanning probe microscopy device according to claim 5, further comprising a shield heating system arranged to heat the shield member.

7. The scanning probe microscopy device according to claim 6, wherein the shield heating system is arranged to maintain a temperature of the shield member between 400 and 700 kelvins, preferably between 500 and 600 kelvins.

8. The scanning Scanning probe microscopy device according to claim 2, further comprising a holder heating system arranged to heat the substrate holder, in particular the substrate holding portion.

9. The scanning probe microscopy device according to claim 8, wherein the holder heating system comprises a laser unit arranged to emit a laser beam towards the cylindrical holder, wherein the holder is provided with an optical system arranged to direct the beam through the holder towards the cylindrical side of the holder.

10. The scanning probe microscopy device according to claim 9, wherein the cylindrical holder is provided with an inner space and an aperture into the inner space, wherein the laser unit is arranged to direct the laser beam into the inner space through the aperture, wherein the optical system comprises an optical element provided in the inner space and arranged to direct the laser beam towards the substrate holding portion.

11. The scanning probe microscopy device according to claim 8, wherein the holder heating system is arranged to heat a second portion of the substrate holder, wherein the second portion is positioned adjacent to the probe in the deposition state.

12. The scanning probe microscopy device according to claim 10, wherein the optical element is arranged to split the laser beam into a first beam and a second beam, wherein the optical system is arranged to direct the first beam towards the substrate holding portion and the second beam towards the second portion.

13. The scanning probe microscopy device according to claim 11, wherein the holder heating system is arranged to maintain a first temperature of the substrate holding portion and a second temperature of the second portion, wherein a difference between the first temperature and the second temperature is less than 100 kelvins, preferably less than 50 kelvins.

14. The scanning probe microscopy device according to claim 1, wherein the probe is movable in a scanning plane parallel to the substrate held by the substrate holding portion in the scanning state.

15. A material deposition device, comprising a scanning probe microscopy device according to claim 1 and a material deposition unit, in particular a pulsed laser deposition unit, for depositing a material layer onto a substrate, wherein the material deposition unit is arranged to deposit a material layer on a surface of a substrate held by the substrate holding portion in the deposition state.

16. A method of scanning a surface of a material layer, comprising the steps of:
a. providing a material deposition substrate;
b. providing a scanning probe microscopy device according to claim 1, wherein the substrate holding portion holds the substrate;
c. providing a material layer on a surface of the substrate;
d. moving the substrate holder to the scanning state;
e. scanning a surface of the material layer in the scanning state, using the probe.

17. The method according to claim 16, wherein the step of providing the scanning probe microscopy device comprises providing a material deposition device according to claim 15, wherein the step of providing the material layer on the substrate surface comprises depositing the material layer on the substrate surface in the deposition state, using the material deposition unit.

18. The method according to claim 17, comprising the steps of alternatingly rotating the substrate holder between the deposition state, in which material is deposited, and the scanning state, in which the surface of the material layer on the substrate is scanned.
